(19) United States
(12) Patent Application Publication
(10) Pub. No.: US 2025/0382023 A1
(43) Pub. Date: Dec. 18, 2025

(54) METHOD FOR CONTROLLING A VEHICLE COMBINATION, AND VEHICLE COMBINATION

(71) Applicant: ZF CV SYSTEMS GLOBAL GMBH, Bern (CH)

(72) Inventor: Oliver WULF, Neustadt (DE)

(21) Appl. No.: 19/111,339

(22) PCT Filed: Sep. 7, 2023
(86) PCT No.: PCT/EP2023/074517

§ 371 Date: Mar. 13, 2025

(30) Foreign Application Priority Data
Sep. 16, 2022 (DE) 10 2022 123 801.6

(51) Int. Cl. B62D 53/12; B60G 17/016; B60S 9/02; B62D 33/08; B62D 53/06; B62D 53/08

(52) U.S. Cl. CPC B62D 53/12; B60G 17/0161; B60S 9/02; B62D 33/08; B62D 53/06; B62D 53/0842; B60G 2300/044; B60G 2500/324

(57) ABSTRACT

The invention relates to a method for controlling a vehicle combination (1) consisting of a tractor vehicle (1a) and a semitrailer (1b), wherein at least one support winch (16) having a leg member (16b) and a support foot (16c) fastened to the latter on the bottom side is arranged on the semitrailer (1b), wherein the leg member (16b) can be adjusted between an extended position (S1) and a retracted position, wherein the semitrailer (1b) is coupled to the tractor vehicle (1a) during a coupling operation, and/or the semitrailer (1b) is decoupled from the tractor vehicle (1a) during a decoupling operation. According to the invention, it is provided that the leg member (16b) in question is adjusted in automated fashion between an intermediate position and the extended position (S1), or vice versa, while the vehicle combination (1) is at a standstill and is in the parking position (PA), and/or the leg member (16b) in question is adjusted in automated fashion between the intermediate position (SZ) and the retracted position, or vice versa, while the semitrailer (1b) during the coupling process (AV) is moved away from the parking position (PA) or during the decoupling process (BV) is moved in the direction of the parking position (PA), in particular while the vehicle combination (1) is not at a standstill.

### CROSS REFERENCE TO RELATED APPLICATIONS

This application is a U.S. National Phase application under 35 U.S.C. § 371 of International Application No. PCT/EP2023/074517, filed on Sep. 7, 2023, and claims benefit to German Patent Application No. DE 10 2022 123 801.6, filed on Sep. 16, 2022. The International Application was published in German on Mar. 21, 2024 as WO 2024/056496 A1 under PCT Article 21 (2).

### FIELD

The present disclosure relates to a method for controlling a vehicle combination and to a vehicle combination with a towing vehicle and a semitrailer.

### BACKGROUND

The prior art discloses methods in which a towing vehicle is moved manually closer to a target object, e.g. a semitrailer, in order to dock with the latter. This generally takes a lot of effort since the driver manually adjusts a height of a hitch plate (5th wheel) on the towing vehicle, in which a kingpin of the semitrailer can be received and fixed, and then moves the towing vehicle manually closer to the semitrailer. While being monitored, the hitch plate is then moved manually closer to the kingpin in order to fix the latter in the hitch plate.

Methods for facilitating the coupling process after the manual approach are already known from DE 10 2006 057 610 A1, DE 10 2014 110 498 A1, DE 10 2019 104 352 A1, WO2007102777A1, EP 1 740 400 B1 and EP 1 874 616 B1. In order to enable a coupling process which is as quick and gentle as possible, during which damage to the kingpin and/or the hitch plate is avoided, DE 10 2016 011 323 A1 furthermore envisages that the contact between the hitch plate of the towing vehicle and the upper coupler plate of the semitrailer, which is located above the kingpin, is determined from a change in the actuating speed or in an actual height gradient, wherein the actual height gradient indicates the change in height between the at least one rear axle of the towing vehicle and a vehicle body, on which the hitch plate is secured.

EP 2 921 350 B1 furthermore describes a method which assists the driver of a towing vehicle during a process of approach to a trailer to be coupled and, for this purpose, using image data from a camera as a basis, determines a setpoint trajectory along which the towing vehicle should be moved for the coupling process.

US 20190367107 A1 furthermore discloses a method which, in addition to an automated coupling process, also comprises an automated process of approach to a semitrailer by the towing vehicle, wherein, for this purpose, the semitrailer is located by a camera, and then an approach of the kingpin to the hitch plate is performed by automated control of the towing vehicle.

The problem with such automated approach processes is that a support or a landing leg, by means of which the semitrailer is supported on the ground in the uncoupled state, is normally raised and lowered manually. Given that the individual steps (coupling, automated manual actuation of supports, and driving away) are carried out in succession, the throughput of a process designed for automation, e.g. at a depot, is limited, particularly by this manual actuation of the supports.

### SUMMARY

In an embodiment, the present disclosure provides. . . .

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a two-part vehicle comprising a towing vehicle and a semitrailer;

FIG. 1a shows a detail view of a fifth wheel coupling of the towing vehicle according to FIG. 1;

FIGS. 2a and 2b show flow charts for methods according to the present disclosure;

FIGS. 3, 4 and 5 show the two-part vehicle according to FIG. 1 during a coupling process; and

FIG. 6 shows a schematic view of a connection between the semitrailer and the towing vehicle.

### DETAILED DESCRIPTION

In an embodiment, the present disclosure provides a method for controlling a vehicle combination by means of which the automation process, e.g. at a depot, can be optimized. A vehicle combination is also provided.

Thus, according to the present disclosure, in a method for controlling a vehicle combination consisting of a towing vehicle and a semitrailer, it is envisaged that a leg member of at least one landing leg on the semitrailer, which leg member is adjustable with at least one intermediate stage or in an infinitely variable manner, is actuated in an automated manner, e.g. electrically, pneumatically or hydraulically, between an intermediate position and an extended position or vice versa while the semitrailer coupled to the towing vehicle, or the vehicle combination, is stationary and in a parking position, and/or
the respective leg member of the landing leg is adjusted in an automated manner between the intermediate position and the retracted position or vice versa while the semitrailer coupled to the towing vehicle is moved away from the parking position during the coupling process or in the direction of the parking position during the uncoupling process. Here therefore, the coupling process comprises coupling the semitrailer to the towing vehicle and adjusting the leg members while stationary at the parking position and/or during a movement of the vehicle combination away from the parking position, that is to say a process of collection from the parking position. Similarly, the uncoupling process comprises adjusting the leg members during a movement of the vehicle combination in the direction of the parking position and/or at the parking position and also the uncoupling of the semitrailer from the towing vehicle, i.e. a process of bringing it to the parking position.

It is therefore envisaged that,
during the coupling process, the respective leg member is adjusted in an automated manner out of the extended position into the intermediate position while the semitrailer previously coupled to the towing vehicle is stationary and in the parking position, and/or
during the uncoupling process, the respective leg member is adjusted in an automated manner out of the intermediate position into the extended position while the semitrailer still coupled to the towing vehicle is stationary and in the parking position, and/or
during the coupling process, the respective leg member is adjusted in an automated manner out of the intermediate position into the retracted position while the semitrailer previously coupled to the towing vehicle is moved away from the parking position, and/or
during the uncoupling process, the respective leg member is adjusted in an automated manner out of the retracted position into the intermediate position while the semitrailer still coupled to the towing vehicle is moved toward the parking position.

It is also advantageously provided for the leg member of the landing leg, which can be adjusted with at least one intermediate stage or in an infinitely variable manner between an extended position, in which the semitrailer can be supported on an underlying surface via a supporting foot on the leg member, and a retracted position, to be adjusted proportionately while stationary and proportionately while driving, wherein
the proportion of the movement between the extended position and the intermediate position (in both directions) takes place while stationary and in the parking position, and
the proportion of the movement between the intermediate position and the retracted position (in both directions) takes place while driving (away from the parking position or to the parking position). Accordingly, use is made of the fact that the proportion of the movement which does not impair driving of the vehicle combination can also be carried out while driving. The respective processes are thus carried out at least partially in parallel or simultaneously, thereby making it possible to save time overall, especially if the coupling process and the uncoupling process are carried out in a fully automated manner. However, it is also conceivable for the automated movement according to the present disclosure of the leg members to take place during manual driving or during a manual coupling process or uncoupling process.

During a coupling process, the semitrailer is coupled to the towing vehicle in an automated manner or manually at a parking position in that the towing vehicle approaches the semitrailer with the respective leg member in the extended position in an automated manner or manually in such a way that a kingpin on the semitrailer enters a coupling aperture in a hitch plate of the towing vehicle, and the kingpin can be fixed pivotably in the coupling aperture in the hitch plate by means of a locking device. An electric and/or hydraulic and/or pneumatic connection is then formed between the towing vehicle and the coupled semitrailer, e.g. manually or in an automated manner. During an uncoupling process, the semitrailer is uncoupled from the towing vehicle in an automated manner or manually at the parking position, with the respective leg member in the extended position, by releasing the kingpin in the coupling aperture of the hitch plate by means of the locking device and then moving the towing vehicle away from the semitrailer in an automated manner or manually before the electric and/or hydraulic and/or pneumatic connection between the towing vehicle and the coupled semitrailer is divided in an automated manner or manually.

According to the present disclosure, a vehicle combination for carrying out the method is also provided, wherein the method can be coordinated or carried out by a coupling control device.

There is furthermore preferably provision for the intermediate position to be reached when the respective leg member is at a percentage intermediate value between the retracted position and the extended position, wherein the percentage intermediate value is between 30% and 90% (relative to the extended state), preferably 60%, the respective leg member thus being between 70% and 10%, preferably 40%, retracted and/or between 30% and 90%, preferably 60%, extended.

These percentage intermediate values ensure that, during a movement of the vehicle combination, the supporting feet at least do not touch a level underlying surface, thereby making it possible simultaneously to achieve a timesaving in the automation process and reliable driving.

Alternatively or in addition, it can be envisaged that the intermediate position is reached when a predefined intermediate adjustment value for the respective leg member is reached, wherein the intermediate adjustment value is between a maximum adjustment travel corresponding to the extended position and a minimum adjustment travel corresponding to the retracted position.

It is thus also provided to measure or detect or monitor an adjustment travel, wherein the intermediate adjustment travel then corresponds to the abovementioned percentage intermediate value. It is also provided to detect the actual position of the leg members as a percentage value during adjustment or as an absolute value (adjustment travel), and to determine on the basis of the respective value whether the defined intermediate position has been reached.

Provision is furthermore preferably made for the towing vehicle to have a level control system, wherein a height of the chassis of the towing vehicle relative to a rear axle of the towing vehicle can be changed by actuating the level control system between a minimum height and a maximum height, wherein the height of the chassis relative to the rear axle is changed in an automated manner in the direction of the maximum height, for example to the maximum height, before the respective leg member is adjusted in an automated manner between the intermediate position and the retracted position during a movement of the semitrailer.

It has been recognized here that the leg members or supporting feet on the semitrailer can additionally be adjusted upward in the coupled state by raising the vehicle chassis of the towing vehicle on which the hitch plate is seated. The semitrailer, which is thus pivotably connected, is then also raised, and therefore an even smaller adjustment of the leg members when stationary and at the parking position of the semitrailer is required to achieve a certain distance between the supporting feet of the landing legs and the underlying surface. It is thereby provided to further optimize the automation process since an even larger proportion of the adjustment of the leg members can take place during a movement of the vehicle combination.

Provision is therefore preferably made for the percentage intermediate value and/or the intermediate adjustment value to be adapted as a function of the set height of the chassis relative to the rear axle. Thus, provision can be made, for example, for the intermediate position to be reached after a percentage intermediate value of just 80% or a corresponding intermediate adjustment value.

Provision is furthermore preferably made for the semitrailer coupled to the towing vehicle to be moved away from the parking position in an automated manner during the coupling process, or to be moved in the direction of the parking position in an automated manner during the uncoupling process, by automated control of the towing vehicle by a movement control device, such that, for example, the towing vehicle is moved along a setpoint trajectory, wherein the movement control device controls and/or moves the towing vehicle in an automated manner with at least one constraint as long as the leg members are between the intermediate position and the retracted position. Thus, the automated control of the towing vehicle takes place subject to conditions until the leg members are completely retracted, thereby further increasing safety.

In this case, provision can be made, for example, for the movement control device to control and/or move the towing vehicle in an automated manner with the constraint that
the towing vehicle does not exceed a defined limit speed of, for example, 20 km/h, and/or
the towing vehicle is situated on an underlying surface with a slope of less than 5%, preferably less than 2%, in particular less than 1%, thus ensuring that contact with the underlying surface can be reliably avoided, and/or
the towing vehicle is situated on or moving along an underlying surface with objects, e.g. curbstones, bollards, speed bumps, potholes, etc., below a defined limiting object height, in order to avoid a collision between the still extended leg members or supporting feet and the respective object while the retracted position has not yet been reached.

According to one embodiment, provision is furthermore preferably made for the respective leg member to be adjusted in an automated manner out of the extended position into the intermediate position while the semitrailer previously coupled to the towing vehicle is stationary and in a first parking position, and/or for the semitrailer coupled to the towing vehicle to be moved out of the first parking position into a second parking position, e.g. in an automated manner, while the respective leg member is in the intermediate position, and for the respective leg member to be adjusted in an automated manner out of the intermediate position into the extended position when stationary and in the second parking position in order then to uncouple the semitrailer. In this way, unnecessary complete retraction and extension of the leg members can be avoided, thereby making it possible to save effort and prevent excessively rapid wear of the respective components.

As a preferred option, it is furthermore envisaged that, during an uncoupling process, the respective leg member is adjusted in an automated manner out of the retracted position into the intermediate position as soon as an enable signal is present, wherein the enable signal is generated and output as soon as the semitrailer enters a defined zone around the parking position and/or there is a manual driver input, e.g. via a corresponding user control element. It is therefore advantageously provided to define a zone within which adjustment of the leg members can already be initiated, in some embodiments subject to a limiting movement of the vehicle, in order then to have the leg members already adjusted into the intermediate position when the parking position is reached. In the case of a manual approach, the extension of the leg members into the intermediate position can be performed by a corresponding driver input.

In this case, provision can be made for the respective leg member to be adjusted in an automated manner out of the retracted position in such a way that, during an uncoupling process, the respective leg member reaches the intermediate position before, as soon as or after the semitrailer has reached the parking position and is stationary. Since this is an automation process, the movements of the vehicle combination are already known, for example, from the setpoint trajectory. It is therefore provided to estimate approximately when the semitrailer is at the parking position and accordingly also at what time the leg members are adjusted in advance from the retracted position into the intermediate position. If the intermediate position is reached even before the parking position or the stationary condition, provision is preferably made to hold the leg member in the intermediate position until the parking position is reached.

The present disclosure is explained in greater detail below by means of an exemplary embodiment.

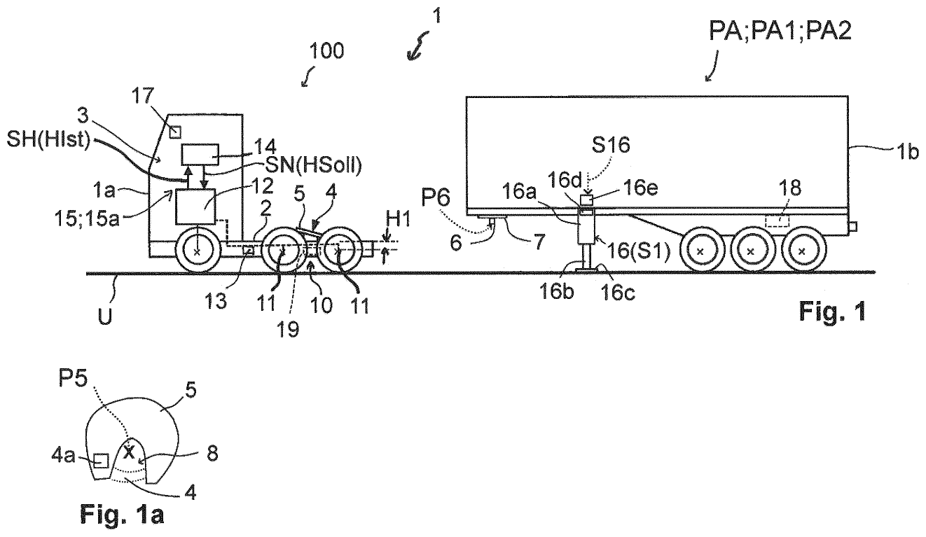

FIG. 1 shows schematically a two-part vehicle combination 1, in particular a commercial vehicle, which consists of a towing vehicle 1a and a semitrailer 1b parked at a parking position PA. The towing vehicle 1a has a chassis 2 or vehicle frame, on which the driver's cab 3 and a coupling device or fifth wheel coupling having a hitch plate 5 (5th wheel) for coupling the semitrailer 1b to the towing vehicle la are located. Secured on the semitrailer 1b, underneath an upper coupler plate 7, is a kingpin 6 or coupling pin, wherein the kingpin 6 is received in a coupling aperture 8 (see FIG. 1a) in the hitch plate 5 of the towing vehicle 1a and can be locked or fixed therein by means of a locking device 4 or lock, e.g. a locking bar or a clamp, in order to couple the semitrailer 1b pivotably to the towing vehicle 1a. In this case, the locking device 4 can be actuated in an automated manner by means of a locking control device 4a in order to ensure automated locking/fixing of the kingpin in the coupling aperture 8 during a coupling process AV and also automated detachment or release of the kingpin 6 during an uncoupling process BV.

The towing vehicle 1a furthermore has a level control system 10, e.g. an ECAS (“Electronically Controlled Air Suspension”), by means of which the chassis 2 can be actively raised or lowered relative to one or more rear axles 11 of the towing vehicle 1a. Since the coupling device is firmly connected by the hitch plate 5 to the chassis 2, a height of the hitch plate 5 relative to the rear axle(s) 11 and therefore also relative to an underlying surface U is also simultaneously set by means of the level control system 10.

The level control system 10 is controlled by a level-controlling control device 12. In the presence of a level control signal SN, this can actively raise or lower the chassis 2 in corresponding fashion relative to the rear axle(s) 11, e.g. by actively admitting or releasing air to or from spring bellows of the level control system 10. The level control signal SN can, for example, include a setpoint height value HSoll, by means of which the level-controlling control device 12 can specify a desired height H between the chassis 2 and the rear axle(s) 11.

Furthermore, the level control system 10 has a height sensor 13, which is designed to measure the current height H between the chassis 2 and the rear axle(s) 11. By means of a height signal SH, the level control system 10 can output a corresponding actual height value HIst, which characterizes the currently measured height H. From this actual height value HIst, it is provided in principle, by simple geometrical considerations, also to derive the height between the hitch plate 5 and the rear axle(s) 11 or the underlying surface U.

A coupling control device 14, by means of which a coupling process AV and an uncoupling process BV can be controlled, is furthermore provided in the towing vehicle 1a. In this case, the coupling control device 14 is designed to read in the height signal SH with the actual height value HIst and to output a level control signal SN with a corresponding setpoint height value HSoll to the level-controlling control device 12 in order to actively demand lowering or raising of the towing vehicle 1a.

For this purpose, the coupling control device 14 can be integrated into the level-controlling control device 12 or, alternatively, can be provided as an external unit, e.g. for retrofitting or expansion of an existing level control system 10. As an external unit, the coupling control device 14 can communicate with the level-controlling control device 12 via a data bus 15 for example, e.g. a CAN bus 15a, in order to exchange the signals SN, SH.

The semitrailer 1b of the vehicle combination 1 furthermore has landing legs 16 on both sides, which serve to support the semitrailer 1b on the underlying surface U when it is not coupled to the towing vehicle 1a. Here, a landing leg 16 has a housing 16a, which is fixedly connected to the semitrailer 1b and in which a leg member 16b with a supporting foot 16c is movably guided. A landing leg actuator 16d, e.g. an electric motor or a pneumatic or hydraulic system, acts on the leg member 16d in such a way that the latter moves relative to the housing 16a and thereby raises or lowers the supporting foot 16c.

By means of a landing leg control device 16e, the landing leg actuator 16d can be controlled in accordance with an automatically specified landing leg signal S16. The landing leg signal S16 can be transmitted from the coupling control device 14 to the landing leg control device 16e by wire, e.g. via the data bus 15, in particular the CAN bus 15a, or wirelessly, e.g. via a WLAN connection 9. In this way, the leg member 16b can be adjusted with at least one intermediate stage or continuously between an extended position S1, in which the supporting feet 16c are supported on the underlying surface U, e.g. in the uncoupled state, and a retracted position S2 for the coupled state or for driving. Here, the landing leg control device 16e is capable of determining a current actual position SIst of the leg member 16b during actuation of the landing leg actuator 16d, and of outputting said position (via the wired (15, 15a) or wireless (9) connection), e.g. as a percentage value between 100% (extended position S1) and 0% (retracted position S2) or as an absolute value between a maximum adjustment travel Vmax (extended position S1) and a minimum adjustment travel Vmin (retracted position S2). The actual position SIst can be estimated, e.g. by sensor measurement or else from an adjustment time and an adjustment speed of the leg member 16b.

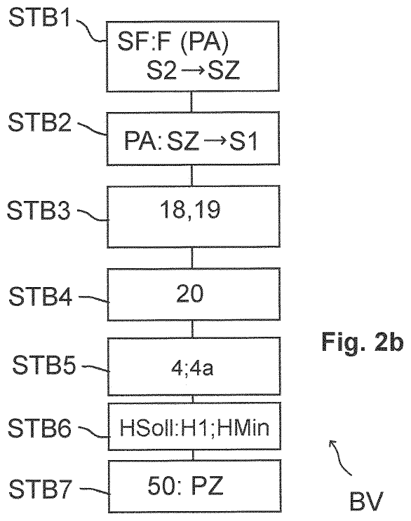

Furthermore, the towing vehicle 1a has a movement control unit 50 (see FIG. 3), which is capable of controlling a drive system 51, a braking system 52 and a steering system 53 of the towing vehicle 1a in an automated manner in order to move the towing vehicle 1a in a longitudinal direction X. The towing vehicle 1a can thereby be moved in a fully automated manner along a defined setpoint trajectory TSoll in order to approach the semitrailer 1b to be coupled in an approach process NV or to move the towing vehicle 1a with the coupled semitrailer 1b (after a coupling process AV) or else only the towing vehicle 1a (after an uncoupling process BV) away from the parking position PA.

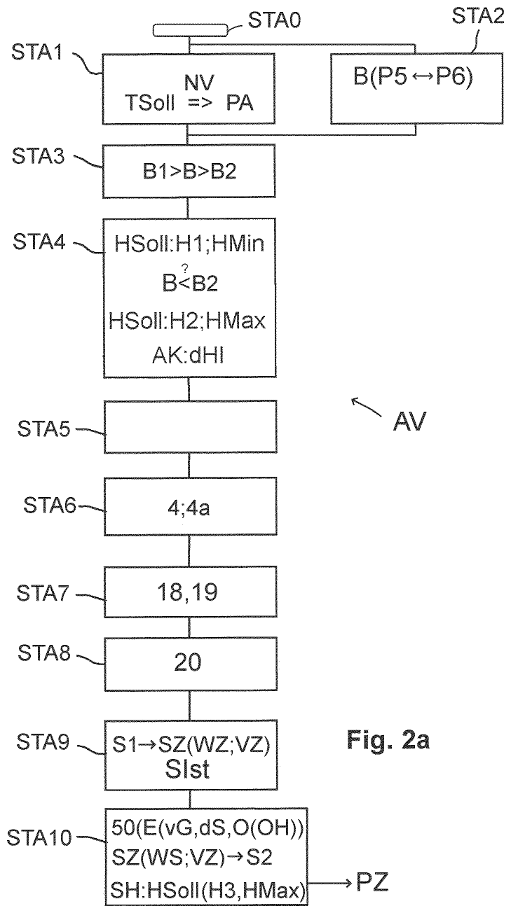

In this case, the level control system 10 or level-controlling control device 12, the coupling control device 14, the locking control device 4a, the landing leg control device 16e and the movement control unit 50 are connected to one another in any desired manner for signal transmission, e.g. via the data bus 15, in particular the CAN bus 15a, of the towing vehicle 1a, and form a coupling arrangement 100, which is coordinated centrally, e.g. by the coupling control device 14. By means of this coupling arrangement 100, a fully automated coupling process AV or a fully automated uncoupling process BV between the towing vehicle 1a and the semitrailer 1b is made possible, as described below with reference to FIGS. 2a and 2b, said process having the following steps:

For a coupling process AV, a semitrailer 1b is identified and located at a parking position PA in the environment U in an initial coupling step STA0, and a setpoint trajectory TSoll is determined on this basis. In a first coupling step STA1, the towing vehicle 1a is moved in an automated manner along the setpoint trajectory TSoll in the direction of the parking position PA by appropriate control of the movement control unit 50 in order, in an automated approach process NV, to approach the semitrailer 1b to be coupled.

In a second coupling step STA2, which is carried out in parallel with the automated approach process NV in the first coupling step STA1, a longitudinal distance B (see FIG. 3) between a hitch plate reference point P5 (see FIG. 1a), which is located centrally in the coupling aperture 8 of the hitch plate 5 for example, and a kingpin reference point P6 (see FIG. 1), which is located directly on the kingpin 6 for example, is continuously determined. Here, the longitudinal distance B indicates how close the kingpin 6 has already approached to the hitch plate 5 in the lateral direction X during the automated approach process NV.

If it is detected in a third coupling step STA3 that the longitudinal distance B has fallen below a first longitudinal safety distance B1 of, for example, 4 m and, at the same time, is above a second safety distance B2 of, for example, 1.2 m, control of the level control system 10 is initiated in a fourth coupling step STA4, this being accompanied by an indication signal for example. As part of this process, automatic adaptation of the height H of the towing vehicle 1a is performed as follows, for example:

First of all, it must be ensured that the height H between the chassis 2 of the towing vehicle 1a and the rear axle(s) 11 is set in such a way that the towing vehicle 1a can continue to reverse toward the semitrailer 1b to be coupled. For this purpose, the coupling control device 14 specifies a first height value H1, e.g. a minimum height HMin, as a setpoint height value HSoll for the level-controlling control device 12 by means of the level control signal SN. This first height value H1 is defined in such a way that, after the setting of the first height value H1, the towing vehicle 1a can be moved closer to the semitrailer 1b to be coupled without the hitch plate 5 and the upper coupler plate 7 being able to come into contact. The kingpin 6 should also preferably be higher than the hitch plate 5 in order to avoid contact during the approach. This state is illustrated in FIG. 1. During the setting of the first height value H1, e.g. the minimum height HMin, the towing vehicle 1a can be briefly halted or, during this process, can continue to approach the semitrailer 1b to be coupled.

The towing vehicle 1a is then moved closer to the parked semitrailer 1b in an automated manner by means of the movement control unit 50 in such a way that the hitch plate 5 and the upper coupler plate 7 overlap at least partially in the lateral direction X, wherein the hitch plate 5 is situated below the upper coupler plate 7 without touching the latter. This can be ensured, for example, by checking whether the longitudinal distance B is less than the longitudinal second safety distance B2. At the same time, it is ensured that the kingpin 6 does not come into lateral overlap with the hitch plate 5, for instance by monitoring that the longitudinal distance B does not fall below a value of 0.7 m after the second longitudinal safety distance B2 has been undershot, wherein all distance data (B1, B2, 0.7 m) may have to be adapted, depending on the design. If this is the case (B<B2), the towing vehicle 1a is brought to a halt or held stationary by means of the movement control unit 50.

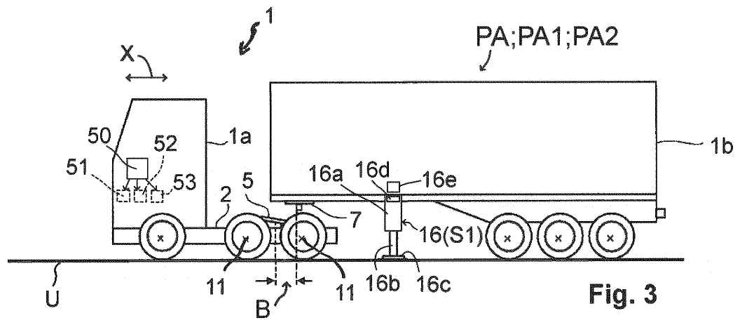

Raising of the chassis 2 is then demanded by the specification of a second height value H2, e.g. a maximum height HMax, as a setpoint height value HSoll to the level-controlling control device 12 by means of the level control signal SN. As a result, the hitch plate 5 approaches the upper coupler plate 7, which has been brought into overlap, as illustrated in FIG. 4. By evaluation of the height signal SH or the actual height values HIst included therein, a coupling criterion AK is then checked, said criterion indicating whether the upper coupler plate 7 is touching the hitch plate 5. This can be accomplished, for example, by evaluation of a current speed of the raising of the chassis 2 or from an actual height gradient dHI and comparison with an expected profile of the actual height gradient (reference height gradient). From this it follows, for example, whether the upper coupler plate 7 is acting on the hitch plate 5 at the current actual height value HIst. This is because the change in the height of the chassis 2 or the actual height gradient dHI determined indicates directly how fast the hitch plate 5 is being raised since said plate is fixedly connected to the chassis 2. Contact between the hitch plate 5 and the upper coupler plate 7 therefore also has direct effects on the movement of the chassis 2 and hence on the actual height gradient dHI:

If the upper coupler plate 7 is not resting against the hitch plate 5, it may be expected that the actual height gradient dHI corresponds to a reference height gradient since there is no additional load acting on the chassis 2 and the latter is being raised unhindered. However, if the actual height gradient dHI associated with a particular actual height value HIst differs from the reference height gradient, which is likewise associated with this actual height value HIst, an additional load is acting on the chassis 2, primarily via the hitch plate 5, owing to the weight of the semitrailer 1b.

The coupling criterion AK is therefore satisfied for the respective semitrailer 1b if it can be assumed from a comparison of the actual height gradient dHI with an expected profile of the actual height gradient (reference height gradient) that the semitrailer 1b, specifically the upper coupler plate 7, is acting on the towing vehicle 1a, specifically the hitch plate 5. In principle, however, the coupling criterion AK can also be checked in some other way during the coupling process AV.

If the coupling criterion AK is satisfied, it is provided to output, via the level control signal SN, that the current actual height value HIst is being used as the setpoint height value HSoll, whereupon the raising of the chassis 2 is stopped by means of the level control system 10. If the coupling criterion AK is not satisfied, the raising of the chassis 2 is continued.

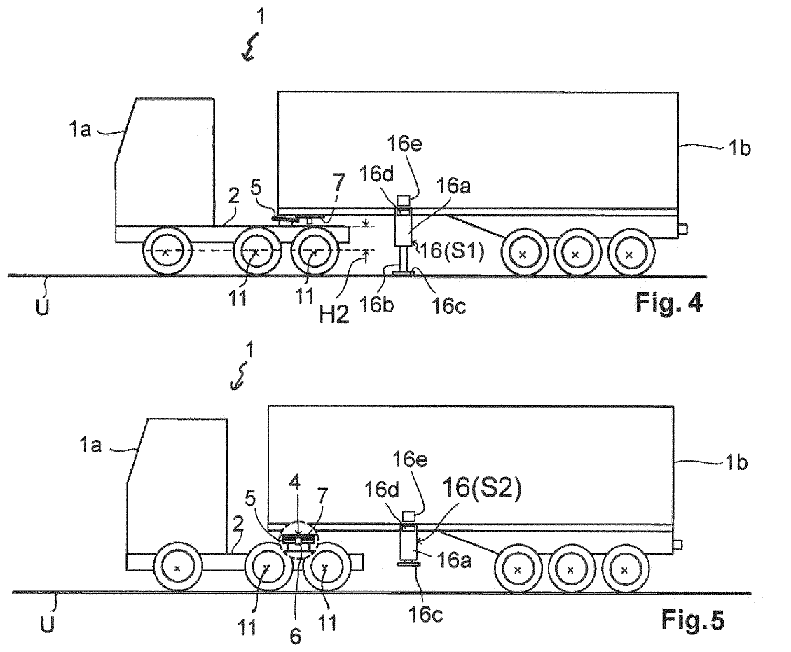

If the coupling criterion AK is satisfied and further raising of the chassis 2 is stopped, the towing vehicle la can continue to be moved closer to the semitrailer 1b to be coupled in a subsequent fifth coupling step STA5 by means of the movement control unit 50 (see FIG. 5), wherein it is provided for this purpose additionally to demand lowering of the towing vehicle la by means of the level control signal SN in order to facilitate the reception of the kingpin 6 in the coupling aperture 8.

Given exact alignment, it can be provided in principle, even at this stage, for the towing vehicle la to be moved closer to the semitrailer 1b to be coupled in such a way that the kingpin 6 is above the coupling aperture 8. With adjustment of the height H by means of the level control system 10 in the fourth coupling step STA4, the kingpin 6 would then ideally enter the coupling aperture 8, and it would be provided to detect contact between the upper coupler plate 7 and the hitch plate 5 by monitoring the actual height gradient dHIst, as described. The fifth coupling step STA5 could then be omitted.

In a sixth coupling step STA6, the locking device 4 can then be actuated by automated control by means of the locking control unit 4a in order to fix the kingpin 6 in the coupling aperture 8. For this purpose, it is provided to have recourse to sensors in the locking device 4, which are able to detect whether the kingpin 6 is in the correct position in the coupling aperture 8, thereby making it possible to ensure that actuation of the locking device 4 takes place at the correct time.

In a seventh coupling step STA7, a semitrailer parking brake 18 on the coupled semitrailer 1b and/or a towing vehicle parking brake 19 on the towing vehicle 1a are/is automatically applied in this coupled state in order to reliably hold the towing vehicle 1a stationary together with the coupled semitrailer 1b. In the figures, the parking brakes 18, 19 are illustrated in a highly schematic way.

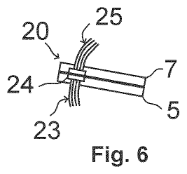

In an eighth coupling step STA8, an electric and/or hydraulic and/or pneumatic connection 20 is then formed between the towing vehicle 1a and the coupled semitrailer 1b. For this purpose, it is provided, for example, to connect towing vehicle lines 23 on the towing vehicle 1a to semitrailer lines 25 on the coupled semitrailer 1b in an automated manner in the region of the hitch plate 5 and the upper coupler plate 7 via a plug and socket connection 24 (see FIG. 6). This can be accomplished by the plug and socket connection 24 being automatically formed by plugging them together when the kingpin 6 is locked in the coupling aperture 8, or else by means of a robot arm, which forms the plug and socket connection 24 by plugging them together. Once the connection 20 has been formed, it is then provided to check whether the electronic semitrailer systems 26 (e.g. the braking system in the semitrailer 1b) are operational.

In a ninth coupling step STA9, the landing legs 16 or the landing leg actuator 16c of the coupled semitrailer 1b are/is then actuated in order to bring the leg members 16b into the retracted position S2. For this purpose, the landing leg control unit 16e is automatically controlled by the coupling control device 14 by means of a corresponding landing leg signal S16. The leg members 16d of the respective landing leg 16 are then adjusted out of the extended position S1 into the retracted position S2, wherein this takes place over a certain time period of between 30 seconds and 60 seconds (depending on the type of landing leg actuator 16d).

In order to accelerate the automation process at the depot, the towing vehicle 1a with the coupled semitrailer 1b is set in motion in an automated manner by means of the movement control unit 50 in a tenth coupling step STA10 as soon as it is detected that the leg members 16b have reached a defined intermediate position SZ during retraction. The intermediate position SZ can be reached, for example, when it follows from the current actual position SIst of the leg members 16b that the leg members 16b are at a percentage intermediate value WZ of, for example, 60% or have already been retracted by 40% and can still be retracted by 60%. If a percentage value is directly determined and output as the actual position SIst by the landing leg control unit 16e, the reaching of the percentage intermediate value WZ can be read off directly. If an absolute value is determined as the actual value SIst by the landing leg control unit 16e, it is provided to define an intermediate adjustment value VZ corresponding to the intermediate position SZ, the reaching of which is then correspondingly monitored.

In this case, the intermediate position SZ or the percentage intermediate value WZ or the (absolute) intermediate adjustment value VZ is defined in such a way that contact between the landing legs 16 or supporting feet 16c and a level underlying surface U can be excluded in the respectively associated position of the leg members 16b. Depending on the design of the semitrailer 1b or the nature of the underlying surface U, different intermediate positions SZ can therefore be defined. This enables the towing vehicle 1a to move the coupled semitrailer 1b away from the parking position PA even before the leg members 16b are in the retracted position S1, thereby making it possible to save time in the automation process.

In order to further optimize the automation process, it is provided, in addition to retracting the leg members 16b into the intermediate position SZ in the tenth coupling step STA10, to provide for the coupling control device 14 to demand raising of the chassis 2 by means of the level control signal SN, e.g. by specifying a third height value H3, preferably a maximum height HMax, as the setpoint height value HSoll. As a result, the semitrailer 1b itself and hence also the landing legs 16 are raised in the already coupled state, and as a consequence they move even further away from the underlying surface U. This in turn enables the intermediate position SZ to be adapted, e.g. in such a way that the intermediate position SZ is already achieved when the leg members 16b are at a percentage intermediate value WZ of, for example, 80% or have already been retracted by 20% and can still be retracted by 80%. As a result, the intermediate position SZ is achieved even earlier, thus enabling additional time to be saved in the automation process.

In order to ensure safe driving even when the respective intermediate position SZ has been reached but the retracted position S2 of the leg members 16b has not yet been reached, control of the movement control unit 50 takes place under defined constraints E. The constraints E specified are, for example, a limit speed vG which must not be exceeded, and/or the presence of a level underlying surface U, making it possible to exclude contact between the as yet incompletely retracted supporting feet 16c and a sloping underlying surface U. A level underlying surface U can be assumed, for example, when there is a slope dS of less than 5%, preferably less than 2%, in particular less than 1%, which can be determined by means of appropriate sensors in the towing vehicle 1a. Another constraint E that can be defined is that the towing vehicle 1a is on or moving along an underlying surface U with objects O, e.g. curbstones, bollards, speed bumps, potholes, etc., in the path of the vehicle which are smaller than a defined limiting object height OH. It is thereby provided to exclude contact with such objects, wherein objects O of this kind can be identified or detected, for example, by means of a camera or by means of a predicted movement of the vehicle combination 1 with a knowledge of the surroundings from map data.

If the underlying surface U is not level (slope dS>5%, preferably>2%, in particular>1%) or objects O that are larger or taller than the defined limiting object height OH have been identified or detected on the underlying surface U in the path of the vehicle, activation of the movement control unit 50 and thus movement of the vehicle combination 1 is prevented.

If the leg members 16b of the landing legs 16 are at some time completely in the retracted position S2, the movement control unit 50 is then once again activated in the normal way and without consideration of the constraints E. The chassis 2 can then also be adjusted again to its original height H by means of the level control system 10. The coupling process AV is then finally complete, and the vehicle combination 1 moves further in an automated manner on the defined setpoint trajectory TSoll to a certain target position PZ in the depot.

For an uncoupling process BV, the vehicle combination 1 consisting of the towing vehicle 1a and the coupled semitrailer 1b first of all moves in an automated manner, under the control of the movement control unit 50, along a specified setpoint trajectory TSoll to the parking position PA in the depot, at which the semitrailer 1b is to be uncoupled. If it is ascertained in a first uncoupling step STB1 that there is an enable signal SF, wherein the enable signal SF is generated and output as soon as the vehicle combination 1 has entered a defined zone F around the parking position PA, the landing legs 16 on the coupled semitrailer 1b are then actuated while the automated movement of the vehicle combination 1 is taking place in order to bring the leg members 16b into the extended position S1. For this purpose, the landing leg control unit 16e is controlled by the coupling control device 14 by means of the landing leg signal S16. The leg members 16b of the respective landing leg 16 are then adjusted out of the retracted position S2 in the direction of the extended position S1, wherein this takes place over a certain time period of between 30 seconds and 60 seconds. If the vehicle combination 1 is being moved manually closer to the parking position PA as part of the uncoupling process BV, the enable signal SF can also be generated and output by a manual driver input, e.g. upon actuation of a user control element 17 in the driver's cab 3.

The leg members 16b are extended even before the parking position PA is reached and during the automated movement of the vehicle combination 1 in order to accelerate the automation process in the depot and not to start the extension of the leg members 16b only when the parking position PA has been reached. In order to avoid contact between the supporting feet 16c and the underlying surface U before the semitrailer 1b is in the parking position PA, the leg members 16b are extended only as far as a defined intermediate position SZ before the parking position PA is reached. To achieve this, the zone F and, accordingly, the time at which the landing legs 16 on the coupled semitrailer 1b are actuated in order to bring the leg members 16b into the extended position S1 can be selected in such a way, with a knowledge of the adjustment speed of the leg members 16b, that the intermediate position SZ is reached precisely when the semitrailer 1b has reached the parking position PA and is stationary. This can be estimated in an appropriate manner with a knowledge of the setpoint trajectory TSoll. The extension of the leg members 16b beyond the intermediate position SZ is then continued immediately at the parking position PA if the vehicle combination 1 is no longer moving.

Alternatively, the coupling control device 14 can also activate the landing leg control unit 16e in two steps, wherein, in a first step, the leg members 16b are initially adjusted only as far as the intermediate position SZ by means of the landing leg signal S16 upon entry to the defined zone F. It is only after the parking position PA has been reached and the vehicle combination 1 is thus stationary that, in a second step, the leg members 16b are finally moved (out of the intermediate position SZ) into the extended position S1 by means of the landing leg signal S16.

During the uncoupling process BV, the intermediate position SZ can be reached, for example, when it follows from the current actual position SIst of the leg members 16b that the leg members 16b are at the percentage intermediate value WZ of, for example, 60% or have already been extended by 60% and can still be extended by 40%. If a percentage value is directly determined and output as the actual position SIst by the landing leg control unit 16e, the reaching of the percentage intermediate value WZ can be read off directly. If an absolute value is determined as the actual value SIst by the landing leg control unit 16e, it is provided to define an intermediate adjustment value VZ corresponding to the intermediate position SZ, which is then correspondingly monitored.

In order to further optimize the automation process, it is provided, in addition to extending the leg members 16b into the intermediate position SZ in the first uncoupling step STB1, to provide for the coupling control device 14 to demand raising of the chassis 2 by means of the level control signal SN, e.g. by specifying the third height value H3, preferably a maximum height HMax, as the setpoint height value HSoll. As a result, the semitrailer 1b itself and hence also the landing legs 16 are raised in the still coupled state, and as a consequence they move even further away from the underlying surface U. This in turn enables the intermediate position SZ to be adapted, e.g. in such a way that the intermediate position SZ is achieved only when the leg members 16b are at a percentage intermediate value WZ of, for example, 80% or have already been extended by 80% and can be extended only by another 20%. Thus, the leg members 16b have then only to be extended by another 20% in the parking position PA, and this accelerates the automation process.

In the case of the uncoupling process BV too, the automated movement of the vehicle combination 1 by control of the movement control unit 50 after the actuation of the landing legs 16 or after the extension of the leg members 16b into the intermediate position SZ takes place under defined constraints E. The constraints E specified are, for example, a limit speed vG which must not be exceeded, and/or the presence of a level underlying surface U, making it possible to exclude contact between the as yet incompletely extended supporting feet 16c and a sloping underlying surface U. A level underlying surface U can be assumed, for example, when there is a slope dS of less than 5%, preferably less than 2%, in particular less than 1%, which can be determined by means of appropriate sensors in the towing vehicle 1a. Another constraint E that can be defined is that the towing vehicle 1a is on or moving along an underlying surface U with objects O, e.g. curbstones, bollards, speed bumps, potholes, etc., in the path of the vehicle which are smaller than a defined limiting object height OH. It is thereby provided to exclude contact with such objects, wherein objects O of this kind can be identified or detected, for example, by means of a camera or by means of a predicted movement of the vehicle combination 1 with a knowledge of the surroundings from map data.

If the underlying surface U is not level (slope dS>5%, preferably>2%, in particular>1% or objects O that are larger or taller than the defined limiting object height OH have been identified or detected on the underlying surface U in the path of the vehicle, activation of the movement control unit 50 and thus movement of the vehicle combination 1 is prevented.

Once the parking position PA has been reached and the leg members 16b have been brought into the extended position S1 in a second uncoupling step STB2, and the supporting feet 16c are in contact with the underlying surface U, the semitrailer 1b can be uncoupled from the towing vehicle 1a. For this purpose, in a third uncoupling step STB3, the semitrailer parking brake 18 on the still coupled semitrailer 1b and/or the towing vehicle parking brake 19 on the towing vehicle 1a is applied in an automated manner in order to hold both stationary, and, in a fourth uncoupling step STB4, the electric and/or hydraulic and/or pneumatic connection 20 between the towing vehicle la and the coupled semitrailer 1b is divided. In a fifth uncoupling step STB5, the locking device 4 is actuated by automated control by means of the locking control unit 4a in order to release the kingpin 6 in the coupling aperture 8.

In a sixth uncoupling step STB6, the coupling control device 14 specifies the first height value H1, e.g. the minimum height HMin, as a setpoint height value HSoll for the level-controlling control device 12 by means of the level control signal SN. As a result, the hitch plate 5 on the towing vehicle 1a is moved away from the upper coupler plate 7 on the semitrailer 1b, preferably until the kingpin 6 is higher than the hitch plate 5. This enables the towing vehicle 1a to be moved away from the semitrailer 1b by automated control of the movement control device 50 in a subsequent seventh uncoupling step STB7 after reaching the first height value H1, preferably the minimum height HMin, without the kingpin 6 touching the hitch plate 5. The towing vehicle 1a can then be moved in an automated manner along a corresponding setpoint trajectory TSoll to a target position PZ in the depot without the semitrailer 1b being coupled.

If only a short distance is to be traveled between a coupling process AV at a first parking position PA1 and an uncoupling process BV at a second parking position PA2, it is also made possible to provide for the vehicle combination 1 to be moved in an automated manner from the first parking position PAI to the second parking position PA2 without the leg members 16b of the landing legs 16 being retracted fully into the second position S2. The leg members 16b can then be held in the intermediate position SZ and, in the meantime, the movement control device 50 can be controlled in an appropriate manner, taking into account the constraints E, in order to move the vehicle combination 1 in an automated manner from the first parking position PA1 to the second parking position PA2. It is thereby provided to speed up automation processes within the depot and to minimize wear since the landing legs 16 are actuated less often and the leg members 16b are not adjusted over the entire adjustment travel.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### Reference Signs (Part of the Description)

1 vehicle combination
1a towing vehicle
1b semitrailer
2 chassis
3 driver's cab
4 locking device
4a locking control unit
hitch plate
6 kingpin
7 upper coupler plate
8 coupling aperture
9 WLAN connection
level control system
11 rear axle of the towing vehicle 1a
12 level-controlling control device
13 height sensor
14 coupling control device
15 data bus
15a CAN bus
16 landing leg
16a housing
16b leg member
16c supporting foot
16d landing leg actuator
16e landing leg control device
17 user control element
18 semitrailer parking brake
19 towing vehicle parking brake
20 connection between towing vehicle la and semitrailer 1b
23 towing vehicle lines
24 plug and socket connection
25 semitrailer lines
50 movement control unit
51 drive system
52 braking system
53 steering system
100 coupling arrangement
AK coupling criterion
AV coupling process
B longitudinal distance between P5 and P6
B1 first longitudinal safety distance
B2 second longitudinal safety distance
BV uncoupling process
dHI actual height gradient
E constraint
ds slope
F zone
H height between the chassis 2 and the rear axle 11
H1 first height value
H2 second height value
H3 third height value
HIst actual height value
HMax maximum height
HMin minimum height
HSoll setpoint height value
NV approach process
O object
OH limiting object height
P5 upper coupler plate reference point
P6 kingpin reference point
PA parking position
PA1 first parking position
PA2 second parking position
PZ target position
S1 extended position
S2 retracted position
SIst actual position
SF enable signal
SH height signal
SN level control signal
SZ intermediate position
TSoll setpoint trajectory
U underlying surface
vG limit speed
VMax maximum adjustment travel
VMin minimum adjustment travel
VZ intermediate adjustment travel
WZ percentage intermediate value
X longitudinal direction
STA1-STA10 coupling steps of the coupling process AV
STB1-STB7 uncoupling steps of the uncoupling process BV

1. A method for controlling a vehicle combination comprising a towing vehicle and a semitrailer, wherein the towing vehicle has a chassis and a hitch plate arranged thereon, and the semitrailer has an upper coupler plate with a kingpin, wherein,
in a coupled state, the kingpin is configured to be fixed pivotably in a coupling aperture in the hitch plate by means of a locking device, and
at least one landing leg having a leg member and a supporting foot secured on the underside thereof is arranged on the semitrailer, wherein the leg member is configured to be adjusted between an extended position, in which the semitrailer is supported on an underlying surface via the supporting foot, and a retracted position, the method comprising:
coupling the semitrailer to the towing vehicle during a coupling process at a parking position in an automated manner and, adjusting the leg member out of an extended position in the direction of the retracted position once the semitrailer is coupled, and/or
uncoupling the semitrailer from the towing vehicle during an uncoupling process at the parking position in an automated manner and adjusting the leg member into the extended position before the uncoupling of the semitrailer,
wherein the leg member is adjusted in an automated manner between an intermediate position and the extended position or vice versa while the vehicle combination is stationary and in the parking position, and/or
wherein the leg member is adjusted in an automated manner between the intermediate position and the retracted position or vice versa while the semitrailer coupled to the towing vehicle is moved away from the parking position during the coupling process, or is moved in the direction of the parking position during the uncoupling process while the vehicle combination is not stationary.

2. The method as claimed in claim 1, wherein the intermediate position is reached when the leg member is at a percentage intermediate value between the retracted position and the extended position, wherein the percentage intermediate value is between 30% and 90%, preferably 60%, the leg member thus being between 70% and 10%, retracted and/or between 30% and 90% extended.

3. The method as claimed in claim 1, wherein the intermediate position is reached when a predefined intermediate adjustment value for the respective leg member is reached, wherein the intermediate adjustment value is between a maximum adjustment travel corresponding to the extended position and a minimum adjustment travel corresponding to the retracted position.

4. The method as claimed in claim 2, wherein the towing vehicle furthermore has a level control system, wherein a height of the chassis of the towing vehicle relative to a rear axle of the towing vehicle is configured to be changed by actuating the level control system between a minimum height and a maximum height,
wherein the height of the chassis relative to the rear axle is changed in an automated manner in a direction of the maximum height before or while the leg member is adjusted in an automated manner between the intermediate position and the retracted position during a movement of the semitrailer.

5. The method as claimed in claim 4, wherein the percentage intermediate value and/or the intermediate adjustment value is adapted as a function of the set height of the chassis relative to the rear axle.

6. The method as claimed in claim 1 wherein the semitrailer coupled to the towing vehicle is moved away from the parking position in an automated manner during the coupling process, or is moved in a direction of the parking position in an automated manner during the uncoupling process, by automated control of the towing vehicle by a movement controller, such that, for example, the towing vehicle is moved along a setpoint trajectory, wherein the movement controller controls and/or moves the towing vehicle in an automated manner with at least one constraint as long as the leg members is between the intermediate position and the retracted position.

7. The method as claimed in claim 6, wherein the movement controller controls and/or moves the towing vehicle in an automated manner with the at least one constraint that:
the towing vehicle does not exceed a defined limit speed, and/or
the towing vehicle is situated on an the underlying surface (U) with a slope of less than 5%, and/or
the towing vehicle is situated on or moving along the underlying surface with objects below a defined limiting object height.

8. The method as claimed in claim 1. wherein the leg member is adjusted in an automated manner out of the extended position into the intermediate position while the semitrailer previously coupled to the towing vehicle is stationary and in a first parking position, and/or the semitrailer coupled to the towing vehicle is moved out of the first parking position into a second parking position while the leg member is in the intermediate position, and the leg member is adjusted in an automated manner out of the intermediate position into the extended position when stationary and in the second parking position in order to uncouple the semitrailer.

9. The method as claimed in claim 1, comprising:
during the coupling process (AV), adjusting the leg member is in an automated manner out of the extended position into the intermediate position while the semitrailer previously coupled to the towing vehicle is stationary and in the parking position, and/or
during the uncoupling process, adjusting the respective leg member in an automated manner out of the intermediate position into the extended position while the semitrailer still coupled to the towing vehicle is stationary and in the parking position, and/or
during the coupling process (AV), adjusting the leg member in an automated manner out of the intermediate position into the retracted position while the semitrailer previously coupled to the towing vehicle is moved away from the parking position, and/or
during the uncoupling process, adjusting the leg member in an automated manner out of the retracted position into the intermediate position while the semitrailer still coupled to the towing vehicle is moved in the direction of the parking position.

10. The method as claimed in claim 1, comprising:
during an uncoupling process, adjusting the leg member is in an automated manner out of the retracted position into the intermediate position as soon as an enable signal is present, wherein the enable signal is generated and output as soon as the semitrailer enters a defined zone around the parking position and/or there is a manual driver input via a user control element.

11. The method as claimed in claim 1, wherein the leg member is adjusted in an automated manner out of the retracted position such that, during an uncoupling process, the leg member reaches the intermediate position before, as soon as or after the semitrailer has reached the parking position and is stationary.

12. The method as claimed in claim 11, wherein, until the parking position is reached, the leg member is held in the intermediate position if the intermediate position has already been reached.

13. A vehicle combination consisting of:
a towing vehicle; and
a semitrailer configured to be coupled to the towing vehicle, wherein the towing vehicle has:
a chassis and a hitch plate arranged thereon, and p2 a coupling controller configured to carry out the method as claimed in claim 1, wherein the semitrailer has:
an upper coupler plate with a kingpin, wherein, in the coupled state, the kingpin is configured to be fixed pivotably in a coupling aperture in the hitch plate of the towing vehicle by means of a locking device, and
at least one landing leg having a leg member and a supporting foot secured on an underside thereof, wherein the leg member is configured to be adjusted in an automated manner by a landing leg actuator between an extended position, in which the semitrailer is configured to be supported on an underlying surface via the supporting foot, and a retracted position,
wherein the coupling controller configured to couple the semitrailer to the towing vehicle during a coupling process at a parking position, and, once the semitrailer is coupled, to adjust the leg member out of the extended position in a direction of the retracted position, and/or
to uncouple the semitrailer from the towing vehicle during an uncoupling process at the parking position, and to adjust the respective leg member into the extended position while the semitrailer is still coupled,
wherein the coupling controller is further configured to:
adjust the leg member in an automated manner between an intermediate position and the extended position or vice versa while the semitrailer coupled to the towing vehicle is stationary and in the parking position, and/or
adjust the leg member in an automated manner between the intermediate position and the retracted position or vice versa while the semitrailer coupled to the towing vehicle is adjusted away from the parking position during the coupling process, or is moved in the direction of the parking position during the uncoupling process while the semitrailer coupled to the towing vehicle is not stationary.

14. The vehicle combination as claimed in claim 13, wherein the towing vehicle has a movement controller which is configured to actuate a drive system, a braking system and a steering system of the towing vehicle in an automated manner in order to move the coupled semitrailer away from the parking position during the coupling process or to move the semitrailer to be uncoupled in a direction of the parking position during the uncoupling process.
